(19) United States
(12) Patent Application Publication
(10) Pub. No.: US 2020/0178177 A1
(43) Pub. Date: Jun. 4, 2020

(54) METHOD AND DEVICE FOR TRANSMITTING OR RECEIVING WAKE-UP PACKET IN WIRELESS LAN SYSTEM

(71) Applicant: LG ELECTRONICS INC, Seoul (KR)

(72) Inventor: Sanggook KIM, (US)

(73) Assignee: LG ELECTRONICS INC, Seoul (KR)

(21) Appl. No.: 16/638,112

(22) PCT Filed: Aug. 8, 2018
(86) PCT No.: PCT/KR2018/009035

§ 371 Date: Feb. 10, 2020

Related U.S. Application Data
(60) Provisional application No. 62/543,895, filed on Aug. 10, 2017.

(51) Int. Cl. H04W 52/02; H04W 68/00; H04W 80/02; H04W 4/40

(52) U.S. Cl. CPC H04W 52/0229; H04W 68/005; H04W 84/12; H04W 4/40; H04W 80/02

(57) ABSTRACT

Provided is a method of receiving a packet performed by a wake-up radio (WUR) terminal in a WLAN system is provided. The method includes: receiving, by a WUR terminal including a main radio module and WUR module, a wake-up packet, determining whether the received wake-up packet is a specific wake-up packet indicating execution of a risk notification operation, and performing the risk notification operation indicated by the specific wake-up packet when the received wake-up packet is the specific wake-up packet.

### BACKGROUND OF THE DISCLOSURE

### Field of the Disclosure

The present disclosure relates to wireless communication and, more particularly, to a method of transmitting and receiving a packet in a wireless local area network (WLAN) system and a transmitting terminal/receiving terminal using the same.

### Related Art

Next-generation wireless local area network (WLAN) is under discussion. The next-generation WLAN aims at 1) enhancement of the Institute of Electronic and Electronics Engineers (IEEE) 802.11 physical (PHY) layer and medium access control (MAC) layer in 2.4 GHz and 5 GHz bands, 2) an increase in spectrum efficiency SIP1802-040 and area throughput, 3) enhancement of performance in real indoor and outdoor environments such as environments with interference sources, dense heterogeneous network environments, and environments with high user loads. In addition, a paradigm is shifting from human-oriented communication support to Internet of things (IoT), which requires the efficient use of power for things which are not available for supply of power at all times. Therefore, the IEEE has created a new task group (Task Group ba) to develop a standard protocol that enables communication using ultra-power consumption. Wireless devices based on this standard protocol are referred to as devices that support wake-up radio (WUR).

An environment considered mainly in the next-generation WLAN is a dense environment with many access points (APs) and stations (STAs), and improvement in spectrum efficiency and area throughput in such a dense environment are discussed. In addition, the next generation WLAN is concerned about improvement in substantial performance in an outdoor environment, which has not been much considered in the conventional WLAN, as well as an indoor environment.

Specifically, the next-generation WLAN pays much attention on scenarios such as wireless office, smart-home, stadium, hot spot, and building/apartment based on which enhancement of system performance in the dense environment with many Aps and STAs have been discussed.

Also, in the next generation WLAN, system performance improvement, outdoor environment performance, cellular offloading in an overlapping basic service set (OBSS) environment, and the like, rather than single link performance improvement in one basic service set (BSS), are expected to be actively discussed. Directionality of the next-generation WLAN means that the next-generation WLAN will increasingly have a technology range similar to that of mobile communications. Considering a recent situation in which mobile communication and WLAN technologies are discussed together in a small cell and direct-to-direct (D2D) communication area, technical and business convergence of the next-generation WLAN and mobile communication is anticipated to become more active.

### SUMMARY

The present disclosure provides a method and apparatus for transmitting and receiving a wake-up packet for providing a wake-up radio (WUR) operation in a WLAN system.

The present disclosure also provides a method and apparatus for transmitting and receiving a wake-up packet indicating execution of a specific operation (i.e., a wake-up packet instructing to perform a specific operation).

In an aspect, a method of transmitting a packet, performed by a transmitting terminal, in a WLAN system is provided. The method includes: generating, by the transmitting terminal, a specific wake-up packet for a wake-up radio (WUR) terminal including a main radio module and a WUR module, the specific wake-up packet indicating execution of a risk notification operation (or a danger alert operation) of the WUR terminal, and transmitting the wake-up packet to the WUR terminal.

In another aspect, a method of receiving a packet performed by a WUR terminal in a WLAN system is provided. The method includes: receiving, by a WUR terminal including a main radio module and a wake-up radio (WUR) module, a wake-up packet, determining whether the received wake-up packet is a specific wake-up packet indicating execution of a risk notification operation, and performing the risk notification operation indicated by the specific wake-up packet when the received wake-up packet is the specific wake-up packet.

According to the present disclosure, a wake-up packet indicating execution of a risk notification operation can be signaled adaptively according to a user's situation, so that the WUR terminal may efficiently save power and reduce a risk notification operation time.

According to the present disclosure, a wake-up packet indicating execution of the risk notification operation can be signaled to the WUR terminal in a situation requiring a response within a short time, and thus a time for performing the risk notification operation may be shortened. This contributes to expansion of applicability of the WUR.

### BRIEF DESCRIPTION OF THE DRAWINGS

FIG. 1 is a conceptual view illustrating the structure of a wireless local area network (WLAN).

FIG. 2 is a diagram illustrating an example of a PPDU used in an IEEE standard.

FIG. 3 is a diagram illustrating an example of an HE PDDU.

FIG. 4 is an internal block diagram of a wireless terminal receiving a wake-up packet.

FIG. 5 is a conceptual diagram illustrating a method in which a wireless terminal receives a wake-up packet and a data packet.

FIG. 6 illustrates an example of a format of a wake-up packet.

FIG. 7 illustrates a signal waveform of a wake-up packet.

FIG. 8 is a diagram illustrating a procedure of determining power consumption according to a ratio of a bit value constituting information of a binary sequence form.

FIG. 9 is a diagram illustrating a design process of a pulse according to an OOK technique.

FIG. 10 is a diagram of a duty cycle trap.

FIG. 11 is a diagram illustrating an IOT device in which a low power (or low energy) wake-up receiver described above is not used.

FIG. 12 is a diagram schematically illustrating a method of transmitting a packet by a transmitting terminal in a WLAN system according to the present disclosure.

FIG. 13 is a block diagram illustrating a wireless device to which the present embodiment may be applied.

FIG. 14 is a block diagram illustrating an example of a device included in a processor.

FIG. 15 is a diagram schematically illustrating a method of receiving a packet by a WUR terminal in a WLAN system according to the present disclosure.

### DESCRIPTION OF EXEMPLARY EMBODIMENTS

The above-described features and the following detailed description are exemplary contents for helping a description and understanding of the present specification. That is, the present specification is not limited to this embodiment and may be embodied in other forms. The following embodiments are merely examples to fully disclose the present specification, and are descriptions to transfer the present specification to those skilled in the art. Therefore, when there are several methods for implementing components of the present specification, it is necessary to clarify that the present specification may be implemented with a specific one of these methods or equivalent thereof.

In the present specification, when there is a description in which a configuration includes specific elements, or when there is a description in which a process includes specific steps, it means that other elements or other steps may be further included. That is, the terms used in the present specification are only for describing specific embodiments and are not intended to limit the concept of the present specification. Furthermore, the examples described to aid the understanding of the present specification also include complementary embodiments thereof.

The terms used in the present specification have the meaning commonly understood by one of ordinary skill in the art to which the present specification belongs. Terms commonly used should be interpreted in a consistent sense in the context of the present specification. Further, terms used in the present specification should not be interpreted in an idealistic or formal sense unless the meaning is clearly defined. Hereinafter, embodiments of the present specification will be described with reference to the accompanying drawings.

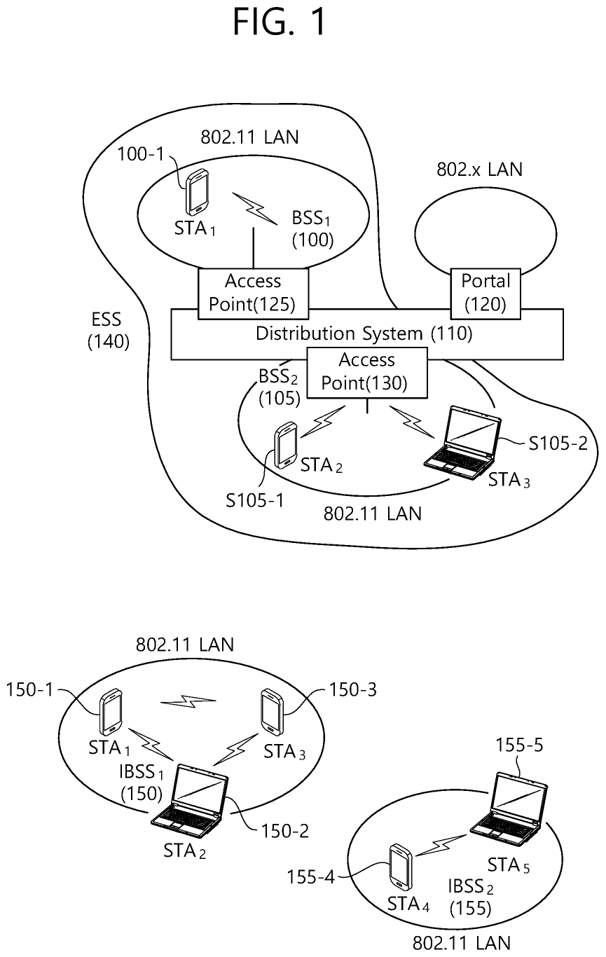

FIG. 1 is a conceptual diagram illustrating a structure of a WLAN system. FIG. 1(A) illustrates a structure of an infrastructure network of institute of electrical and electronic engineers (IEEE) 802.11.

Referring to FIG. 1(A), a WLAN system 10 of FIG. 1(A) may include at least one basic service set (hereinafter, referred to as ‘BSS’) 100 and 105. The BSS is a set of access points (hereinafter, APs) and stations (hereinafter, STAs) that may successfully synchronize and communicate with each other and is not a concept indicating a specific area.

For example, a first BSS 100 may include a first AP 125 and one first STA 100-1. A second BSS 105 may include a second AP 130 and one or more STAs 105-1 and 105-2.

The infrastructure BSSs 100 and 105 may include at least one STA, APs 125 and 130 for providing a distribution service, and a distribution system (DS) 110 for connecting a plurality of APs.

The DS 110 may connect a plurality of BSSs 100 and 105 to implement an extended service set (hereinafter, ‘ESS’) 140. The ESS 140 may be used as a term indicating one network to which at least one AP 125 and 130 is connected through the DS 110. At least one AP included in one ESS 140 may have the same service set identification (hereinafter, SSID).

A portal 150 may serve as a bridge for connecting a WLAN network (IEEE 802.11) with another network (e.g., 802.X).

In a WLAN having a structure as illustrated in FIG. 1(A), a network between the APs 125 and 130 and a network between APs 125 and 130 and STAs 100-1, 105-1, and 105-2 may be implemented.

FIG. 1(B) is a conceptual diagram illustrating an independent BSS. Referring to FIG. 1(B), a WLAN system 15 of FIG. 1(B) may perform communication by setting a network between STAs without the APs 125 and 130, unlike FIG. 1(A). A network that performs communication by setting a network even between STAs without the APs 125 and 130 is defined to an ad-hoc network or an independent basic service set (hereinafter, ‘BSS’).

Referring to FIG. 1(B), an IBSS 15 is a BSS operating in an ad-hoc mode. Because the IBSS does not include an AP, there is no centralized management entity. Therefore, in the IBSS 15, STAs 150-1, 150-2, 150-3, 155-4, and 155-5 are managed in a distributed manner.

All STAs 150-1, 150-2, 150-3, 155-4, and 155-5 of the IBSS may be configured with mobile STAs, and access to a distributed system is not allowed. All STAs of the IBSS form a self-contained network.

The STA described in the present specification is a random function medium including a medium access control (hereinafter, MAC) following a standard of the Institute of Electrical and Electronics Engineers (IEEE) 802.11 standard and a physical layer interface for a wireless medium and may broadly be used as a meaning including both an AP and a non-AP station (STA).

The STA described in the present specification may also be referred to as various names such as a mobile terminal, a wireless device, a wireless transmit/receive unit (WTRU), a user equipment (UE), a mobile station (MS), a mobile subscriber unit, or simply a user.

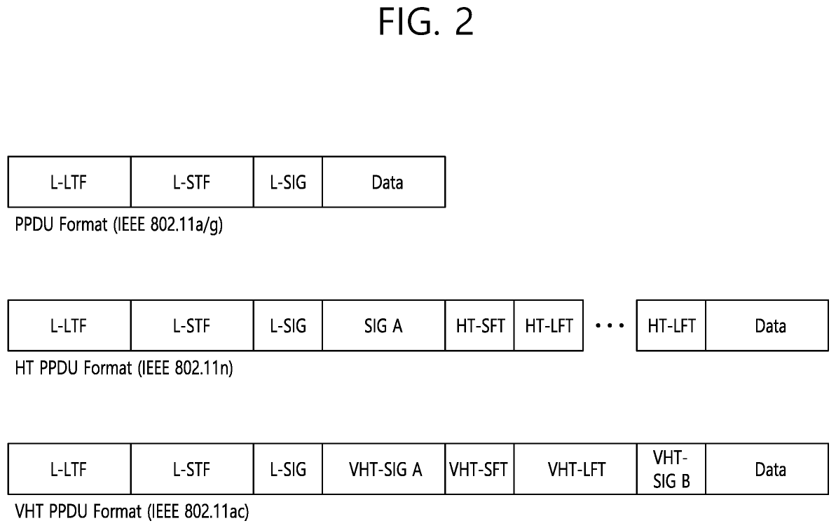

FIG. 2 is a diagram illustrating an example of a PPDU used in an IEEE standard.

As illustrated in FIG. 2, various types of PHY protocol data units (PPDUs) may be used in a standard such as IEEE a/g/n/ac, etc. In detail, LTF and STF fields include a training signal, SIG-A and SIG-B include control information for a receiving station, and a data field includes user data corresponding to a Physical Service Data Unit (PSDU).

In the embodiment, an improved technique is provided, which is associated with a signal (alternatively, a control information field) used for the data field of the PPDU. The signal provided in the embodiment may be applied onto high efficiency PPDU (HE PPDU) according to an IEEE 802.11ax standard. That is, the signal improved in the embodiment may be HE-SIG-A and/or HE-SIG-B included in the HE PPDU. The HE-SIG-A and the HE-SIG-B may be represented even as the SIG-A and SIG-B, respectively. However, the improved signal proposed in the embodiment is not particularly limited to an HE-SIG-A and/or HE-SIG-B standard and may be applied to control/data fields having various names, which include the control information in a wireless communication system transferring the user data.

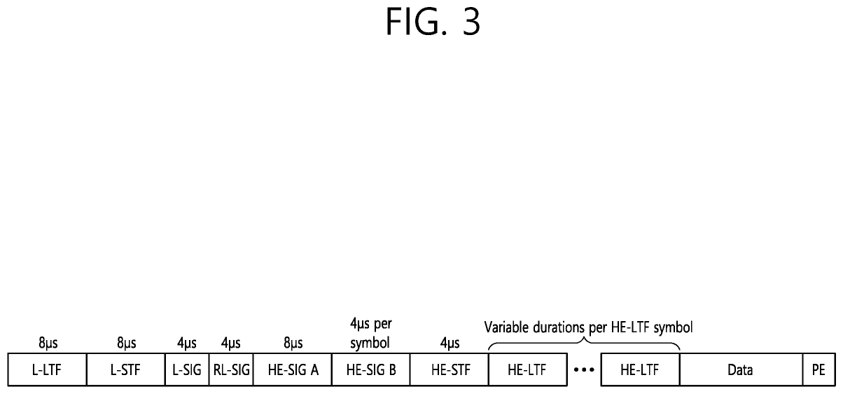

FIG. 3 is a diagram illustrating an example of an HE PDDU.

The control information field provided in the embodiment may be the HE-SIG-B included in the HE PPDU. The HE PPDU according to FIG. 3 is one example of the PPDU for multiple users and only the PPDU for the multiple users may include the HE-SIG-B and the corresponding HE SIG-B may be omitted in a PPDU for a single user.

As illustrated in FIG. 3, the HE-PPDU for multiple users (MUs) may include a legacy-short training field (L-STF), a legacy-long training field (L-LTF), a legacy-signal (L-SIG), a high efficiency-signal A (HE-SIG A), a high efficiency-signal-B (HE-SIG B), a high efficiency-short training field (HE-STF), a high efficiency-long training field (HE-LTF), a data field (alternatively, an MAC payload), and a packet extension (PE) field. The respective fields may be transmitted during an illustrated time period (that is, 4 or 8 μs).

The PPDU used in the IEEE standard is mainly described as a PPDU structure transmitted with a channel bandwidth of 20 MHz. The PPDU structure transmitted with a bandwidth (e.g., 40 MHz and 80 MHz) wider than the channel bandwidth of 20 MHz may be a structure in which linear scaling is applied to the PPDU structure used in the channel bandwidth of 20 MHz.

The PPDU structure used in the IEEE standard may be generated based on 64 Fast Fourier Transforms (FTFs), and a cyclic prefix portion (CP portion) may be ¼ of an effective symbol interval. In this case, a length of an effective symbol interval (or FFT interval) may be 3.2 us, a CP length may be 0.8 us, and symbol duration may be 4 us (3.2 us+0.8 us) that adds the effective symbol interval and the CP length.

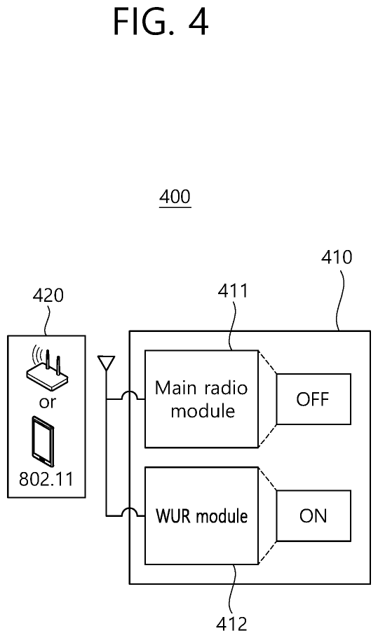

FIG. 4 is an internal block diagram of a wireless terminal receiving a wake-up packet.

Referring to FIG. 4, a WLAN system 400 according to the present embodiment may include a first wireless terminal 410 and a second wireless terminal 420.

The first wireless terminal 410 may include a main radio module 411 related to main radio (i.e., 802.11) and a module 412 (hereinafter, WUR module) including a low-power wake-up receiver (IP WUR′). The main radio module 411 may transmit or receive user data in an active state (i.e., ON state).

When there is no data (or packet) to be transmitted by the main radio module 411, the first radio terminal 410 may control the main radio module 411 to enter an inactive state (i.e., OFF state). For example, the main radio module 411 may include a plurality of circuits supporting Wi-Fi, Bluetooth® radio (hereinafter, BT radio), and Bluetooth® Low Energy radio (hereinafter, BLE radio).

In the related art, a wireless terminal operating based on a power save mode may operate in an active state or a sleep state.

For example, a wireless terminal in an active state may receive all frames from another wireless terminal. Further, a wireless terminal in a sleep state may receive a specific type of frame (e.g., a beacon frame transmitted periodically) transmitted by another wireless terminal (e.g., AP).

It is assumed that a wireless terminal described in the present specification may operate a main radio module in an active state or in an inactive state.

A wireless terminal including a main radio module 411 in an inactive state (i.e., OFF state) may not receive a frame (e.g., 802.11 type PPDU) transmitted by another wireless terminal (e.g., AP) until the main radio module is woken up by the WUR module 412.

For example, a wireless terminal including the main radio module 411 in an inactive state (i.e., OFF state) may not receive a beacon frame periodically transmitted by the AP.

That is, it may be understood that a wireless terminal including a main radio module (e.g., 411) in an inactive state (i.e., OFF state) according to the present embodiment is in a deep sleep state.

Further, a wireless terminal including the main radio module 411 in an active state (i.e., ON state) may receive a frame (e.g., 802.11 type PPDU) transmitted by another wireless terminal (e.g., AP).

Further, it is assumed that a wireless terminal described in the present specification may operate the WUR module in a turn-off state or in a turn-on state.

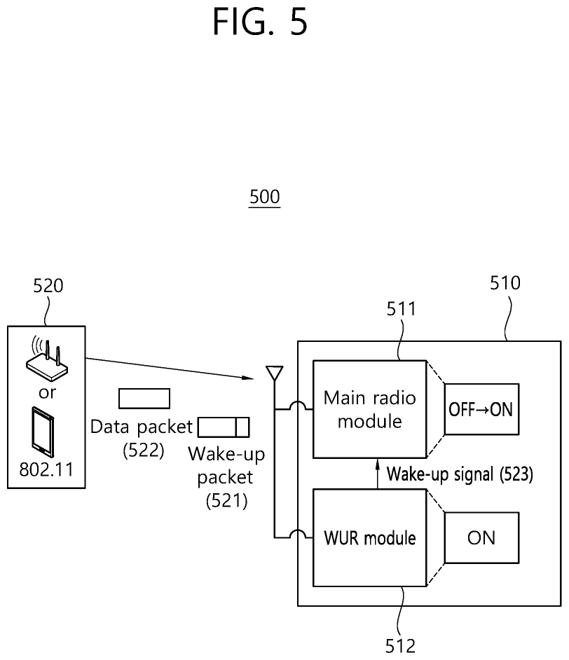

A wireless terminal including the WUR module 412 in a turn-on state may receive only a specific type of frame transmitted by other wireless terminals. In this case, the specific type of frame may be understood as a frame modulated by an on-off keying (OOK) modulation scheme to be described later with reference to FIG. 5.

A wireless terminal including the WUR module 412 in a turn-off state may not receive a specific type of frame transmitted by other wireless terminals.

In the present specification, in order to represent an ON state of a specific module included in the wireless terminal, terms of an active state and a turn-on state may be used interchangeably. In the same context, in order to represent an OFF state of a particular module included in the wireless terminal, terms of an inactive state and a turn-off state may be used interchangeably.

The wireless terminal according to the present embodiment may receive a frame (or packet) from another wireless terminal based on the main radio module 411 or the WUR module 412 in an active state.

The WUR module 412 may be a receiver for waking the main radio module 411. That is, the WUR module 412 may not include a transmitter. The WUR module 412 may maintain a turn-on state for duration in which the main radio module 411 is in an inactive state.

For example, when a wake-up packet (hereinafter, WUP) for the main radio module 411 is received, the first radio terminal 410 may control the main radio module 411 in an inactive state to enter an active state.

The low-power wake-up receiver (LP WUR) included in the WUR module 412 targets target power consumption of less than 100 uW in an active state. Further, the low-power wake-up receiver may use a narrow bandwidth of less than 5 MHz.

Further, power consumption by the low-power wake-up receiver may be less than 100 uW. Further, a target transmission range of the low-power wake-up receiver may be the same as that of existing 802.11.

The second wireless terminal 420 according to the present embodiment may transmit user data based on main radio (i.e., 802.11). The second wireless terminal 420 may transmit a wake-up packet (WUP) for the WUR module 412.

Referring to FIG. 4, the second wireless terminal 420 may not transmit user data or a wake-up packet (WUP) for the first wireless terminal 410. In this case, the main radio module 411 included in the second wireless terminal 420 may be in an inactive state (i.e., OFF state), and the WUR module 412 may be in a turn-on state (i.e., ON state).

FIG. 5 is a conceptual diagram illustrating a method in which a wireless terminal receives a wake-up packet and a data packet.

Referring to FIGS. 4 and 5, a WLAN system 500 according to the present embodiment may include a first wireless terminal 510 corresponding to a receiving terminal and a second wireless terminal 520 corresponding to a transmitting terminal. A basic operation of the first wireless terminal 510 of FIG. 5 may be understood through a description of the first wireless terminal 410 of FIG. 4. Similarly, a basic operation of the second wireless terminal 520 of FIG. 5 may be understood through a description of the second wireless terminal 420 of FIG. 4.

Referring to FIG. 5, when a wake-up packet 521 is received in a WUR module 512 in an active state, the WUR module 512 may transfer a wake-up signal 523 to a main radio module 511 so that the main radio module 511 may accurately receive a data packet 522 to be received after the wake-up packet 521.

For example, the wake-up signal 523 may be implemented based on primitive information inside the first wireless terminal 510.

For example, when the main radio module 511 receives the wake-up signal 523, the main radio module 511 may activate all or only a part of a plurality of circuits (not illustrated) supporting Wi-Fi, BT radio, and BLE radio included therein.

As another example, actual data included in the wake-up packet 521 may be directly transferred to a memory block (not illustrated) of the receiving terminal even if the main radio module 511 is in an inactive state.

As another example, when the wake-up packet 521 includes an IEEE 802.11 MAC frame, the receiving terminal may activate only a MAC processor of the main radio module 511. That is, the receiving terminal may maintain a PHY module of the main radio module 511 in an inactive state. The wake-up packet 521 of FIG. 5 will be described in more detail with reference to the following drawings.

The second wireless terminal 520 may be set to transmit the wake-up packet 521 to the first wireless terminal 510. For example, the second wireless terminal 520 may control the main radio module 511 of the first wireless terminal 510 to enter an active state (i.e., ON state) according to the wake-up packet 521.

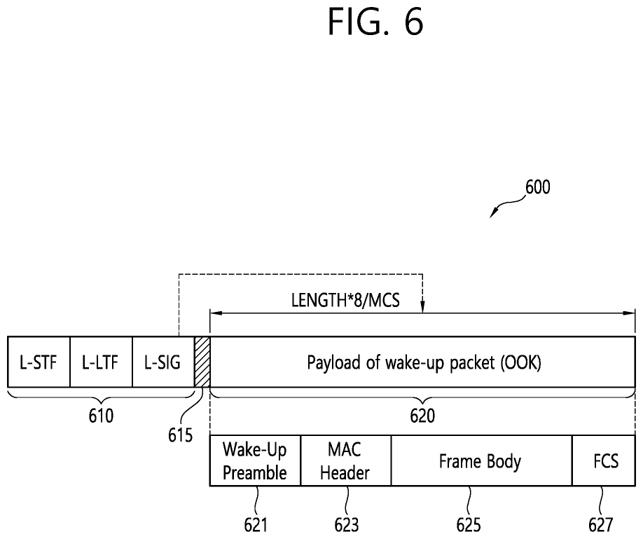

FIG. 6 shows an example of a format of a wake-up packet.

Referring to FIGS. 1 to 6, a wake-up packet 600 may include at least one legacy preamble 610. For example, the legacy preamble 610 may be modulated according to an existing orthogonal frequency division multiplexing (OFDM) modulation technique.

In addition, the wake-up packet 600 may include a payload 620 after the legacy preamble 610. For example, the payload 620 may be modulated according to a simple modulation scheme (e.g., on-off Keying (OOK) modulation scheme). The wake-up packet 600 including the payload may be transmitted based on a relatively small bandwidth.

Referring to FIGS. 1 to 6, the second wireless terminal (e.g., 520) may be configured to generate and/or transmit wake-up packet 521 or 600. The first wireless terminal (e.g., 510) may be configured to process the received wake-up packet 521.

The wake-up packet 600 may include the legacy preamble 610 or any other preamble (not shown) defined in the existing IEEE 802.11 standard.

The wake-up packet 600 may include one packet symbol 615 after the legacy preamble 610. In addition, the wake-up packet 600 may include a payload 620.

The legacy preamble 610 may be provided for coexistence with a legacy STA. In other words, the legacy preamble 610 may be provided for a third party STA (i.e., a STA that does not include an LP-WUR). That is, the legacy preamble 610 may not be decoded by the WUR terminal including the WUR module.

In the legacy preamble 610 for coexistence, an L-SIG field for protecting a packet may be used. For example, a 802.11 STA may detect a start portion of a packet (i.e., a start portion of a wake-up packet) through an L-STF field in the legacy preamble 610. The 802.11 STA may know a last portion of the packet (i.e., a last portion of the wake-up packet) through the L-SIG field in the legacy preamble 610.

In order to reduce a false alarm of the 802.11n terminal, a modulated symbol 615 may be added after the L-SIG of FIG. 6. One symbol 615 may be modulated according to a bi-phase shift keying (BPSK) scheme. The one symbol 615 may have a length of 4 us. The one symbol 615 may have a 20 MHz bandwidth like a legacy part.

The payload 620 may include a wake-up preamble field 621, a MAC header field 623, a frame body field 625, and a frame check sequence (FCS) field 627.

The wake-up preamble field 621 may include a sequence for identifying the wake-up packet 600. For example, the wake-up preamble field 621 may include a pseudo-random noise (PN) sequence.

A MAC header field 624 may include address information (or an identifier of a receiving apparatus) indicating a receiving terminal receiving the wake-up packet 600. The frame body field 626 may include other information of the wake-up packet 600.

The frame body 626 may include length information or size information of the payload. Referring to FIG. 6, the length information of the payload may be calculated based on length information and MCS information included in the legacy preamble 610.

The FCS field 628 may include a cyclic redundancy check (CRC) value for error correction. For example, the FCS field 628 may include a CRC-8 value or a CRC-16 value for the MAC header field 623 and the frame body 625.

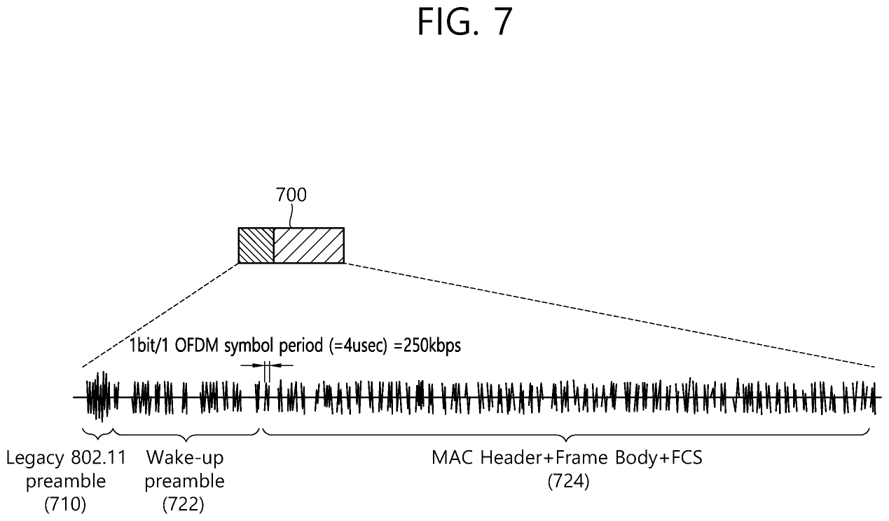

FIG. 7 illustrates a signal waveform of a wake-up packet.

Referring to FIG. 7, a wake-up packet 700 may include a legacy preamble (802.11 preamble) 710 and payloads 722 and 724 modulated based on an On-Off Keying (OOK) technique. That is, the wake-up packet WUP according to the present embodiment may be understood in a form in which a legacy preamble and a new LP-WUR signal waveform coexist.

An OOK technique may not be applied to the legacy preamble 710 of FIG. 7. As described above, the payloads 722 and 724 may be modulated according to the OOK technique. However, the wake-up preamble 722 included in the payloads 722 and 724 may be modulated according to another modulation technique.

For example, it may be assumed that the legacy preamble 710 is transmitted based on a channel band of 20 MHz to which 64 FFTs are applied. In this case, the payloads 722 and 724 may be transmitted based on a channel band of about 4.06 MHz.

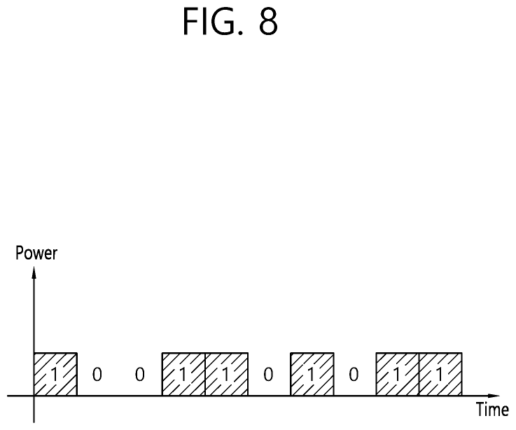

FIG. 8 is a diagram illustrating a procedure of determining power consumption according to a ratio of bit values constituting information of a binary sequence form.

Referring to FIG. 8, information of a binary sequence form having ‘1’ or ‘0’ as a bit value may be represented. Communication according to an OOK modulation scheme may be performed based on bit values of information of a binary sequence form.

For example, when a light emitting diode is used for visible light communication, if a bit value constituting information of a binary sequence form is ‘1’, the light emitting diode may be turned on, and if a bit value constituting information of a binary sequence form is ‘0’, the light emitting diode may be turned off.

As the light emitting diode blinks, the receiver receives and restores data transmitted in the form of visible light, thereby enabling communication using visible light. However, because blinking of the light emitting diode may not be recognized by the human eye, the person feels that lighting is continuously maintained.

For convenience of description, as illustrated in FIG. 8, information of a binary sequence form having 10 bit values may be provided. For example, information of a binary sequence form having a value of ‘1001101011’ may be provided.

As described above, when the bit value is ‘1’, if the transmitting terminal is turned on and when the bit value is ‘0’, if the transmitting terminal is turned off, symbols corresponding to 6 bit values of the above 10 bit values are turned on.

Because the wake-up receiver WUR according to the present embodiment is included in the receiving terminal, transmission power of the transmitting terminal may not be greatly considered. The reason why an OOK technique is used in the present embodiment is because power consumption in a decoding procedure of a received signal is very small.

Until a decoding procedure is performed, there may be no significant difference between power consumed by the main radio and power consumed by the WUR. However, as a decoding procedure is performed by the receiving terminal, a large difference may occur between power consumed by the main radio module and power consumed by the WUR module. The following description is approximate power consumption.
Existing Wi-Fi power consumption is about 100 mW. Specifically, power consumption of resonator+oscillator+PLL (1500 uW)→LPF (300 uW)→ADC (63 uW)→decoding processing (OFDM receiver) (100 mW) may occur.
WUR power consumption is about 100 uW. Specifically, power consumption of decoding processing by an OOK demodulator may occur.

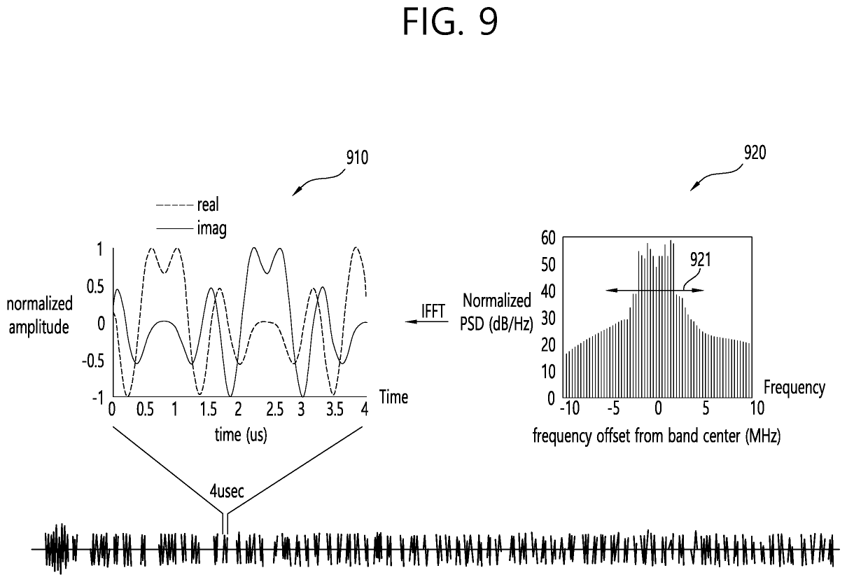

FIG. 9 is a diagram illustrating a design process of a pulse according to the OOK technique.

The wireless terminal according to the present embodiment may use an OFDM transmitting apparatus of the existing 802.11 to generate a pulse according to the OOK technique. The OFDM transmitting apparatus of the existing 802.11 may generate a sequence having 64 bits by applying 64-point IFFT.

Referring to FIGS. 1 to 9, the wireless terminal according to the present embodiment may transmit a payload of a wake-up packet (WUP) modulated according to the OOK technique. The payload (e.g., 620 of FIG. 6) according to the present embodiment may be implemented based on an ON time signal and an OFF time signal.

The OOK technique may be applied to the ON time signal included in the payload (e.g., 620 of FIG. 6) of the wake-up packet (WUP). In this case, the on time signal may be a signal having an actual power value.

Referring to a frequency domain graph 920, the ON time signal included in the payload (e.g., 620 of FIG. 6) may be obtained by performing IFFT on N2 (N2 is a natural number) subcarriers among N1 (N1 is a natural number) subcarriers corresponding to a channel band of the wake-up packet (WUP). In addition, a predetermined sequence may be applied to the N2 subcarriers.

For example, the channel band of the wake-up packet (WUP) may be 20 MHz. N1 subcarriers may be 64 subcarriers, and the N2 subcarriers may be 13 consecutive subcarriers (921 of FIG. 9). The subcarrier interval applied to the wake-up packet (WUP) may be 312.5 kHz.

The OOK technique may be applied to the OFF time signal included in the payload (e.g., 620 of FIG. 6) of the wake-up packet (WUP). The OFF time signal may be a signal that does not have an actual power value. That is, the OFF time signal may not be considered in the configuration of the wake-up packet WUP.

The ON time signal included in the payload (620 of FIG. 6) of the wake-up packet (WUP) may be determined (i.e., demodulated) as a 1-bit ON signal (i.e., ‘1’) by the WUR module (e.g., 512 of FIG. 5). Similarly, the OFF time signal included in the payload may be determined (i.e., demodulated) as a 1-bit OFF signal (i.e., ‘0’) by the WUR module (e.g., 512 of FIG. 5).

A specific sequence may be previously set for a subcarrier set 921 of FIG. 9. In this case, the preset sequence may be a 13-bit sequence. For example, a coefficient corresponding to a DC subcarrier of the 13-bit sequence may be ‘0’, and remaining coefficients may be set to ‘1’ or ‘−1’.

Referring to the frequency domain graph 920, the subcarrier set 921 may correspond to subcarriers having subcarrier indices of ‘−6’ to ‘+6’.

For example, a coefficient corresponding to the subcarriers having subcarrier indices of ‘−6’ to ‘−1’ in the 13-bit sequence may be set to ‘1’ or ‘−1’. A coefficient corresponding to the subcarriers having subcarrier indices of ‘1’ to ‘6’ in the 13-bit sequence may be set to ‘1’ or ‘−1’.

For example, a subcarrier having a subcarrier index of ‘0’ in the 13-bit sequence may be nulled. The coefficients of the remaining subcarriers (subcarrier indices ‘−32’ to ‘−7’ and subcarrier indices ‘+7’ to ‘+31’) except for the subcarrier set 921 may all be set to ‘0’.

The subcarrier set 921 corresponding to 13 contiguous subcarriers may be set to have a channel bandwidth of about 4.06 MHz. That is, power based on a signal may concentrate on 4.06 MHz in a 20 MHz band for the wake-up packet (WUP).

When a pulse based on the OOK technique is used according to the present embodiment, a signal to noise ratio (SNR) may be increased as power concentrates in a specific band, and power consumption for conversion in an AC/DC converter of a receiving apparatus may be advantageously reduced. Since a sampling frequency band is reduced to 4.06 MHz, power consumption by the wireless terminal may be reduced.

Another OFDM transmitting apparatus of 802.11 according to the present embodiment may perform IFFT (e.g. 64-point IFFT) on N2 (e.g., 13) subcarriers among N1 (e.g., 64) subcarriers corresponding to the channel band (e.g., 20 MHz band) of the wake-up packet.

In this case, a preset sequence may be applied to the N2 subcarriers. Accordingly, one ON signal may be generated in a time domain. 1-bit information corresponding to the one ON signal may be transmitted through one symbol.

For example, when the 64-point IFFT is performed, a symbol having a 3.2 us length corresponding to the subcarrier set 921 may be generated. In addition, when cyclic prefix (CP) (0.8 us) is added to a symbol having a length of 3.2 us corresponding to the subcarrier set 921, one symbol having a total length of 4 us as shown in the time domain graph 910 of FIG. 9 may be generated.

In addition, the OFDM transmitting apparatus of 802.11 may not transmit the OFF signal at all.

According to the present embodiment, the first wireless terminal (e.g., 510 of FIG. 5) including the WUR module (e.g., 512 of FIG. 5) may demodulate a received packet based on an envelope detector extracting an envelope of a received signal.

For example, the WUR module (e.g., 512 of FIG. 5) according to the present embodiment may compare a power level of the received signal obtained through the envelope of the received signal with a preset threshold level.

If the power level of the received signal is higher than the threshold level, the WUR module (e.g., 512 of FIG. 5) may determine the received signal as a 1-bit ON signal (i.e., ‘1’). If the power level of the received signal is lower than the threshold level, the WUR module (e.g., 512 of FIG. 5) may determine the received signal as a 1-bit OFF signal (i.e., ‘0’).

According to the present embodiment, a basic data rate of one information may be 125 Kbps (8 us) or 62.5 Kbps (16 us).

When the contents of FIG. 9 is generalized, each signal having a length of K (e.g., K is a natural number) in a 20 MHz band may be transmitted based on K contiguous subcarriers among 64 subcarriers for the 20 MHz band. For example, K may correspond to the number of subcarriers used to transmit the signal. K may also correspond to a bandwidth of a pulse based on the OOK technique.

The coefficients of the subcarriers excluding the K subcarriers among the 64 subcarriers may all be set to ‘0’.

Specifically, the same K subcarriers may be used for the 1-bit OFF signal (hereinafter, information 0) corresponding to ‘0’ and the 1-bit ON signal (hereinafter, information 1) corresponding to ‘1’. For example, indices for the K subcarriers in use may be expressed as 33−floor(K/2): 33+ceil(K/2)−1.

In this case, the information 1 and the information 0 may have the following values.
information 0=zeros(1, K)
information 1=alpha*ones(1, K)

The alpha is a power normalization factor and may be, for example, 1/sqrt(K).

Meanwhile, in the current home appliance industry, Internet of things (IOT) devices have rapidly been increased across different networks from daily home appliances to complex biosensors. In other words, IOT devices have become part of daily life. Also, people expected to be surrounded by 1 billion IOT devices soon.

Therefore, low power consumption and low latency may be required for the IOT devices.

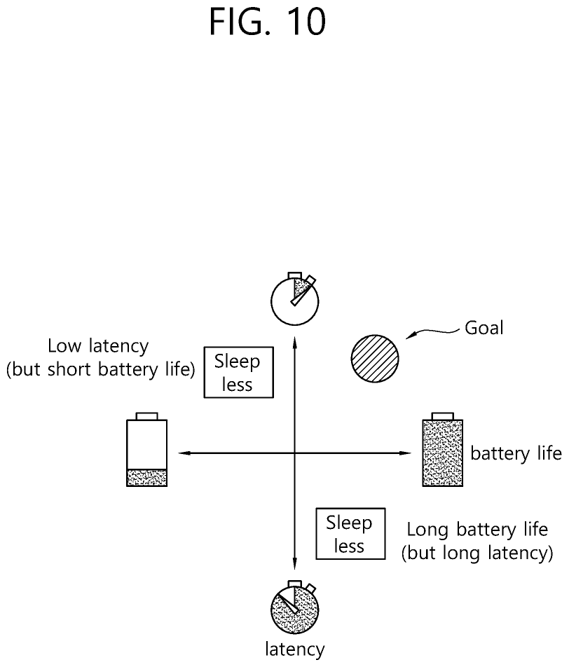

FIG. 10 is a diagram for a duty cycle trap. Although low power consumption and low latency are required for IOT devices, referring to FIG. 10, the low power consumption and low latency are conflicting targets. That is, to increase a battery life of the IOT device, a sleep state may need to be longer. In other words, more latency may be required. In addition in order to receive data with low latency of the IOT device, the sleep state may need to be maintained smaller. In this case, the battery life of the IOT device may be shortened. This operation may be referred to as a duty-cycled operation or a duty cycle trap.

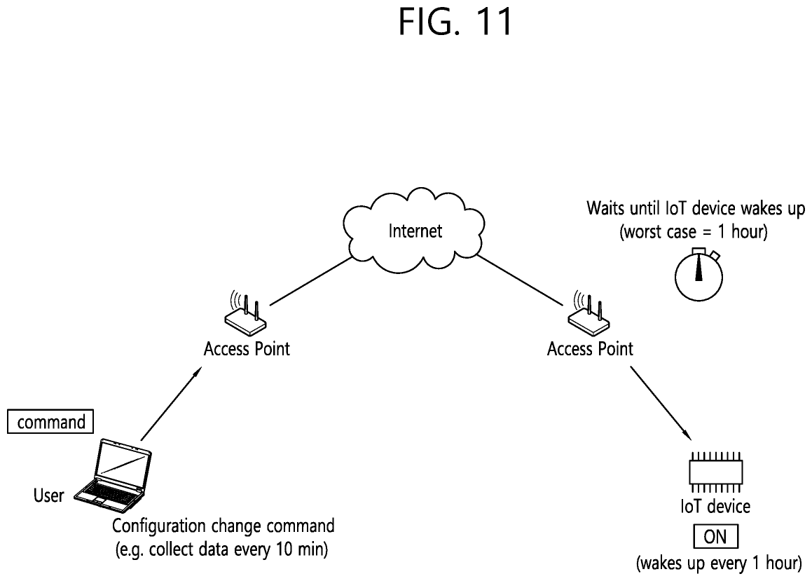

FIG. 11 illustrates an IOT device in which a low power wake-up receiver described above is not used. Referring to FIG. 11, when the low-energy wake-up receiver described above is not used for the IOT devices, the user may not access the IOT device while the IOT device is turned off to save battery. The user must wait until the IOT device wakes up, i.e., until the IOT device is activated. As shown in FIG. 11, when the IOT device wakes up hourly, that is, becomes active, the user may need to wait up to one hour before accessing the IOT device.

Therefore, in order to solve the problem described above, the IOT device including the low power wake-up receiver and the main radio module may be used. The low power wake-up receiver, as a receiver for receiving the wake-up packet as described above, may control the main radio module to enter an inactive state (i.e., an OFF state). The low power wake up receiver may operate in an active state when the main radio module is in an inactive state (i.e., an OFF state), and the low power wake up receiver aims at consumption of less than 100 uW of target power in the active state. When an IOT device including the low power wake-up receiver is used, the user may access the IoT device with a short standby time and the IoT device may have a long battery life.

The wake-up radio (WUR) described above has been proposed as an essential method or device for reducing unnecessary power waste in the IoT era. In future communications, power saving through WUR may be important, which came into prominence in the industry and academia regarding key communication areas (e.g., LTE, 5G, Wi-Fi, LAA-LTE, IoT, etc.), vehicle-to-everything (V2X) services, and applications and is still actively discussed.

However, the WUR may require a time-consuming signal exchange in relation to a case of transmitting a notification mainly regarding a safety-related event, for example, an event that occurs during movement by vehicle, bicycle, walking, or the like.

For example, there may be a vehicle for supporting intelligent transportation systems (ITS), an IOT device installed in road infrastructure, and a portable device (i.e., IOT device) of a pedestrian or a cyclist, and if a risk is detected, a risk notification message may be transmitted to the mobile device (i.e., IOT device) of the pedestrian or the cyclist. The case where the risk is detected may include a case where the pedestrian or the cyclist approaches a dangerous intersection or vehicle. If the pedestrian or the cyclist approaches the dangerous intersection or vehicle, the IOT device installed in the road infrastructure or vehicle may transmit a wake-up packet to send a risk notification message to the portable device of the pedestrian or the cyclist, and the portable device of the pedestrian or the cyclist may receive the wake-up packet and be activated (i.e., ON state). Thereafter, the portable device of the pedestrian or the cyclist may automatically perform a safety radio operation (e.g., an operation of ringing a notification beep together with visual information). However, when the existing WUR is used, a time-consuming signal exchange such as a process of receiving a wake-up packet from a transmitting terminal and transmitting a signal acknowledging reception may be required. Specifically, delay in transmitting the risk notification message in the V2X service and application may include an average time required for the low power wake-up receiver of the portable device to be turned on, an additional time that occurs when a WUR packet is missing, a time for the main radio module (e.g., WLAN, LTE, LTE-Advanced module) to contact a source for the WUR packet, a time for receiving the risk notification message from the source, and the like.

Accordingly, the present disclosure proposes a WUR operation scheme for supporting a service and an application (e.g., V2X) in an emergency situation. For example, a time required in a normal WUR operation may be eliminated or reduced, thereby providing an additional time for the user to cope with an impending risk. That is, the present disclosure may support a time critical service/application even in an operation of a power save mode.

Specifically, the transmitting terminal may generate a specific wake-up packet instructing the main radio module to operate in a turn-on state and to perform an operation in a dangerous situation. For example, the operation in the dangerous situation may be an operation of ringing alert beep with visual information. The specific wake-up packet may be generated by a protocol design, a physical layer (PHY layer) approach, a MAC layer approach, or a hybrid approach method different from the existing wake-up packet indicating only the existing WUR operation. Here, the specific wake-up packet may be referred to as a first wake-up packet, and the existing wake-up packet may be referred to as a second wake-up packet.

For example, the first wake-up packet and the second wake-up packet may be generated using the physical layer approach method. That is, specific sequences may be mapped in a one-to-one manner in transmission of a wake-up packet in specific resources (time and/or frequency).

For example, complementary golay sequences having a certain length may be used. Specifically, a first predetermined sequence combination may be applied to a first subband for the first wake-up packet, and a second sequence combination may be applied to a second subband for the second wake-up packet. For example, when a golay sequence having 64 bits is applied, the first sequence and the second sequence may be derived as shown in the following table.

TABLE 1
The Sequence Ga¹₆₄(n), to be transmitted from left to right, up to down
−1 −1 +1 −1 +1 −1 −1 −1 +1 +1 −1 +1 +1 −1 −1 −1 −1 −1 +1 −1 +1 −1 −1 −1 −1
−1 +1 −1 −1 +1 +1 +1 −1 −1 +1 −1 +1 −1 −1 −1 +1
+1 −1 +1 +1 −1 −1 −1 +1 +1 −1 +1 −1 +1 +1 +1 +1 +1 −1 +1 −1 −1 −1
The Sequence Gb¹₆₄(n), to be transmitted from left to right, up to down
+1 +1 −1 +1 −1 +1 +1 +1 −1 −1 +1 −1 −1 +1 +1 +1 +1 +1 −1 +1 −1 +1 +1 +1 +1 +1 −1
+1 +1 −1 −1 −1 −1 −1 +1 −1 +1 −1 −1 −1 +1 +1 −1 +1 +1 −1 −1 −1 +1 +1 −1 +1 −1 +1
+1 +1 +1 +1 −1 +1 +1 −1 −1 −1
Gₐ¹₆₄(n) represents the first sequence and G_{b}¹₆₄(n) represents the second sequence.

A transmission of a predetermined specific sequence combination in a specific resource (e.g., a specific subband) may be interpreted as a specific message indicating execution of a predetermined operation by the low power wake-up receiver.

Meanwhile, the transmission may be performed in a specific time period, for example, in a part of a preamble of the wake-up packet. In other words, the specific sequence combination may be applied to a specific subband of a specific wake-up packet, and the specific subband may be included in a wake-up preamble field of the specific wake-up packet.

Alternatively, the transmission may be performed in a specific subcarrier set in OFDM. For example, the specific subcarrier set may be derived as 32 subcarriers out of 128 subcarriers using QPSK modulation to transmit a 64-length golay sequence. In other words, the specific sequence combination may be applied to a specific subband of a specific wake-up packet, and the specific subband may be included in a specific subcarrier set of the OFDM. A plurality of OFDM symbols may be used to transmit a predetermined specific sequence combination.

Meanwhile, for example, the first sequence combination and the second sequence combination may be derived as shown in the following table.

TABLE 2

| Value of | | |
|---|---|---|
| a field | Interpretation | Procedure to follow |
| [Gₐ¹₆₄(n) G_{b}¹₆₄(n) Gₐ¹₆₄(n) G_{b}¹₆₄(n)] | Normal best-effort traffic | WLAN module transmits the acknowledgement |
| | will be transmitted from the | of its wake-up to the source |
| | source of this WUR signal | of WUR signal |
| . . . | . . . | . . . |
| [−Gₐ¹₆₄(n) −G_{b}¹₆₄(n) −Gₐ¹₆₄(n) −G_{b}¹₆₄(n)] | WUR signal is | WLAN module lets main processor |
| | transmitted due to | (CPU) sounds “alert” |
| | time-critical event | beep with visual information |

Here, [Gₐ¹₆₄(n), G_{b}¹₆₄(n), Gₐ¹₆₄(n), G_{b}¹₆₄(n)] represents the second sequence combination and [−Gₐ¹₆₄(n), −G_{b}¹₆₄(n), −Gₐ¹₆₄(n), −G_{b}¹₆₄(n)] represents the first sequence combination.

The WUR terminal receiving the specific wake-up packet may derive a sequence combination applied to the subband of the specific wake-up packet and perform an operation indicated by the derived sequence combination. For example, when the sequence combination applied to the subband of the specific wake-up packet is the first sequence combination, the main radio module (e.g., WLAN, LTE, LTE-Advanced module, etc.) of the WUR terminal may perform an operation of ringing alert beep together with visual information. In addition, when the sequence combination applied to the subband of the specific wake-up packet is the second sequence combination, the main radio module (e.g., WLAN, LTE, LTE-Advanced module, etc.) of the WUR terminal may transmit a message for a wake-up acknowledgment.

In another example, the first wake-up packet and the second wake-up packet may be generated using the MAC layer approach method. That is, the operation indicated by the wake-up packet may be interpreted based on a value of the field of the MAC frame of the wake-up packet.

More specifically, the wake-up packet may include a field of x bits in a main message body of a MAC frame, and the main radio module may interpret a reason for transmitting the wake-up field, i.e., which operation the wake-up packet indicates, based on the value of the field.

For example, when the number of bits of the field is 4, operations according to the value of the field may be derived as shown in the following table.

TABLE 3

| Value of | | |
|---|---|---|
| a field | Interpretation | Procedure to follow |
| 0000 | Normal best-effort traffic | WLAN module transmits the |
| | will be transmitted from the | acknowledgement of its |
| | source of this WUR signal | wake-up to the source |
| | | of WUR signal |
| . . . | . . . | . . . |
| 1111 | WUR signal is | Main module lets main |
| | transmitted due to | processor (CPU) sounds |
| | time-critical event | “alert” beep with |
| | | visual information |

For example, when the value of the field in the MAC frame of the received specific wake-up packet is 1111, the main radio module (e.g., WLAN, LTE, LTE-Advanced module, etc.) of the WUR terminal may perform an operation of ringing alert beep together with visual information. Further, when the value of the field in the MAC frame of the specific wake-up packet is 0000, the main radio module (e.g., WLAN, LTE, LTE-Advanced module, etc.) of the WUR terminal may transmit a message for wake-up acknowledgement to a source which has transmitted the specific wake-up packet.

In addition, as another example of the MAC layer approach method, there may be one-to-one mapping between the values of the field and the service/applications. That is, a service/application indicated by the wake-up packet may be derived based on a value of the field of the MAC frame of the wake-up packet.

For example, if the value of the field of the MAC frame of the wake-up packet is 1111, the wake-up packet may be derived as a wake-up packet for the V2X, and if the value of the field of the MAC frame of the wake-up packet is 1110, the wake-up packet may be derived as a wake-up packet for VoIP over, WLAN, or LTE.

In addition, the MAC frame may include the field and a subfield, and a service/application and a message type indicated by the wake-up packet may be derived based on the field and the subfield of the MAC frame. For example, when the value of the field of the MAC frame of the wake-up packet is 1111 and the value of the subfield is 1111, the wake-up packet may indicate a time-critical message for V2X.

Meanwhile, in order to increase a chance of receiving the wake-up packet for the time-critical message, a source (e.g., a car) transmitting the wake-up packet may transmit the wake-up packet in a redundant manner. For example, the transmitting terminal may transmit a plurality of wake-up packets to transmit a warning message about a risk. The transmitting terminal may transmit the wake-up packets by allocating additional power to preset subcarriers and/or through a plurality of transmissions within a specific time.

When the wake-up packet is received by a low power wake-up receiver of the receiving terminal, the main radio module of the receiving terminal may determine whether to perform a general WUR operation or whether to perform an operation regarding a risk notification message based on the wake-up packet. For example, as described above, the main radio module of the receiving terminal may determine whether to perform the operation regarding the risk notification message based on a sequence combination applied to the wake-up packet and/or a field value of a MAC frame. Here, the operation regarding the risk notification message may represent an operation using a multimedia function of the WUR terminal. For example, the operation regarding the risk notification message may indicate an operation of ringing a notification beep by the WUR terminal or an operation of displaying visual information.

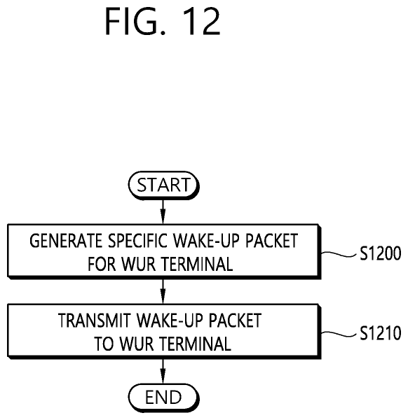

FIG. 12 schematically illustrates a method of transmitting a packet by a transmitting terminal in a WLAN system according to the present disclosure.

Referring to FIGS. 1 to 12, in step S1200, the transmitting terminal may generate a specific wake-up packet for a WUR terminal including a main radio module and a wake-up radio (WUR) module. In this case, the specific wake-up packet may instruct to perform a specific operation of the WUR terminal. In addition, the specific operation may be an operation of displaying visual information and ringing a notification beep. The visual information may represent a preset risk notification image or video. The specific operation may represent a risk notification operation.

Meanwhile, as an example, a specific sequence combination may be applied to a subband included in a wake-up preamble field in the specific wake-up packet, and the specific sequence combination may be previously set to instruct to perform the specific operation. Here, for example, the specific sequence combination may be a combination of golay sequences. The golay sequences may be 64, 128 or 256 in length. The golay sequences may also be represented as shown in Table 1 above. In this case, whether the generated wake-up packet is the specific wake-up packet may be determined based on a sequence combination applied to the subband included in the wake-up preamble field of the generated wake-up packet.

As another example, the specific wake-up packet may include a field having a specific value in a medium access control (MAC) frame, and the specific value may be a value previously set to instruct to perform the specific operation. That is, whether the generated wake-up packet is the specific wake-up packet may be determined based on a field included in the MAC frame of the generated wake-up packet. For example, when the value of the field is 1111, the generated wake-up packet may be determined as the specific wake-up packet indicating execution of the specific operation.

As another example, the MAC frame of the specific wake-up packet may include a field and a subfield, and the field and the subfield may be previously set to specific values indicating execution of a specific operation of a specific service. That is, whether the generated wake-up packet is the specific wake-up packet for a specific service and a specific operation may be determined based on the field and the subfield included in the MAC frame of the generated wake-up packet. For example, when the value of the field is 1111 and the value of the subfield is 1111, the generated wake-up packet may be determined as a specific wake-up packet indicating a time-critical message for V2X.

Meanwhile, the transmitting terminal may be a terminal for a road infrastructure or a vehicle. In this case, when a distance between the transmitting terminal and the WUR terminal is smaller than a predetermined specific value, the transmitting terminal may generate the specific wake-up packet indicating execution of the specific operation. The specific action may be referred to as a risk notification operation.

In step S1210, the transmitting terminal may transmit the wake-up packet to the WUR terminal.

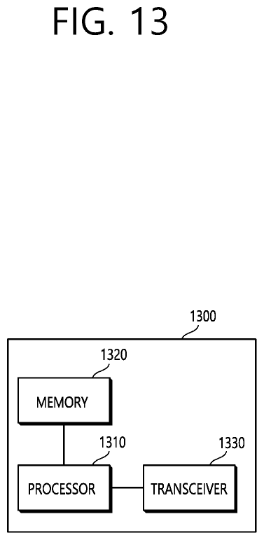

FIG. 13 is a block diagram illustrating a wireless device to which an embodiment of the present disclosure may be applied.

Referring to FIG. 13, the wireless device may be implemented as an STA that may implement the embodiment described above and may operate as an AP or a non-AP STA. In addition, the wireless device may correspond to the user described above or may correspond to a transmitting terminal that transmits a signal to the user.

The wireless device of FIG. 13 includes a processor 1310, a memory 1320, and a transceiver 1330 as illustrated. The illustrated processor 1310, the memory 1320, and the transceiver 1330 may be implemented as separate chips, or at least two blocks/functions may be implemented through one chip.

The transceiver 1330 is a device including a transmitter and a receiver. When a specific operation is performed, only one of the transmitter and the receiver may be performed, or both the transmitter and the receiver may be performed. The transceiver 1330 may include one or more antennas for transmitting and/or receiving wireless signals. In addition, the transceiver 1330 may include an amplifier for amplifying a received signal and/or a transmitted signal and a bandpass filter for transmission on a specific frequency band.

The processor 1310 may implement the functions, processes, and/or methods proposed herein. For example, the processor 1310 may perform an operation according to the embodiment described above. That is, the processor 1310 may perform the operation disclosed in the embodiment of FIGS. 1 to 12.

The processor 1310 may include an application-specific integrated circuit (ASIC), another chipset, a logic circuit, a data processing device, and/or a converter for converting a baseband signal and a wireless signal to and from each other. The memory 1320 may include a read-only memory (ROM), a random access memory (RAM), a flash memory, a memory card, a storage medium, and/or other storage device.

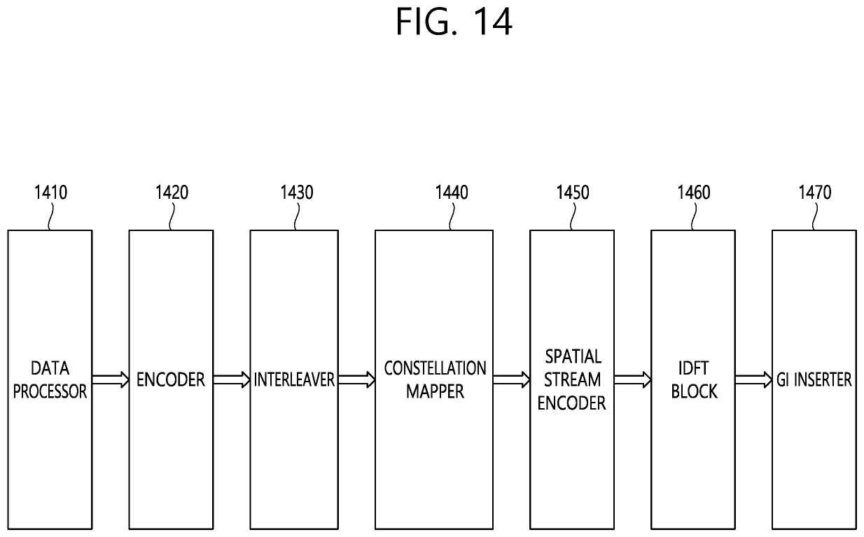

FIG. 14 is a block diagram illustrating an example of a device included in a processor. For convenience of description, the example of FIG. 14 is described based on blocks for a transmitted signal, but it is obvious that a received signal may be processed using the corresponding blocks.

The illustrated data processor 1410 generates transmission data (control data and/or user data) corresponding to a transmitted signal. An output of the data processor 1410 may be input to an encoder 1420. The encoder 1420 may perform coding through a binary convolutional code (BCC) or a low-density parity-check (LDPC) technique. At least one encoder 1420 may be included, and the number of encoders 1420 may be determined according to various information (e.g., the number of data streams).

An output of the encoder 1420 may be input to an interleaver 1430. The interleaver 1430 performs an operation of distributing a continuous bit signal over radio resources (e.g., time and/or frequency) to prevent a burst error due to fading or the like. At least one interleaver 1430 may be included, and the number of the interleavers 1430 may be determined according to various information (e.g., the number of spatial streams).

An output of the interleaver 1430 may be input to a constellation mapper 1440. The constellation mapper 1440 performs constellation mapping such as bi-phase shift keying (BPSK), quadrature phase shift keying (QPSK), n-quadrature amplitude modulation (n-QAM), and the like.

An output of the constellation mapper 1440 may be input to the spatial stream encoder 1450. The spatial stream encoder 1450 performs data processing to transmit a transmitted signal through at least one spatial stream. For example, the spatial stream encoder 1450 may perform at least one of space-time block coding (STBC), cyclic shift diversity (CSD) insertion, and spatial mapping on the transmitted signal.

An output of the spatial stream encoder 1450 may be input to an IDFT block 1460 block. The IDFT block 1460 performs an inverse discrete Fourier transform (IDFT) or an inverse Fast Fourier transform (IFFT).

An output of the IDFT 1460 block is input to a guard interval (GI) inserter 1470, and an output of the GI inserter 1470 is input to the transceiver 1430 of FIG. 13.

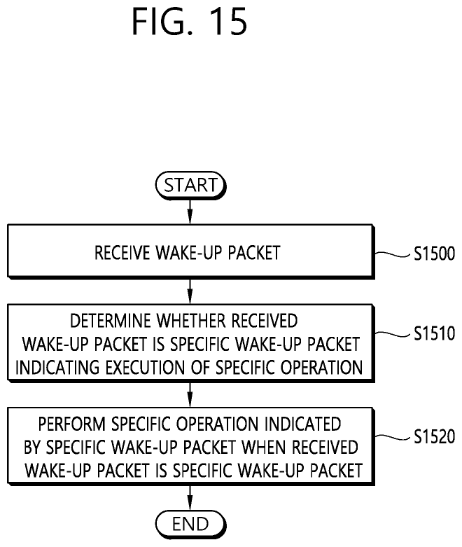

FIG. 15 schematically illustrates a method of receiving a packet by a WUR terminal in a WLAN system according to the present disclosure. The method disclosed in FIG. 15 may be performed by the receiving terminal disclosed in FIG. 5. Specifically, for example, steps S1500 to S1510 of FIG. 15 may be performed by the WUR module of the receiving terminal, and step S1520 may be performed by the main radio module of the receiving terminal.

Referring to FIGS. 1 to 11, in step S1500, the WUR terminal including a main radio module and a WUR module may receive a wake-up packet. The WUR module of the WUR terminal may operate in a turn-on state, and the main radio module may operate in an inactive state. The WUR module of the WUR terminal may receive the wake-up packet.

In step S1510, the WUR terminal may determine whether the received wake-up packet is a specific wake-up packet indicating execution of a specific operation. Here, the specific operation may be an operation of displaying visual information and ringing a notification beep. The visual information may indicate a preset risk notification image or video. In addition, the specific operation may represent a risk notification operation.

Meanwhile, as an example, whether the received wake-up packet is the specific wake-up packet may be determined based on a sequence combination applied to a subband included in a wake-up preamble field of the received wake-up packet. Here, for example, the specific sequence combination may be a combination of golay sequences. The golay sequences may be 64, 128 or 256 in length. The sequence combination may be a combination of golay sequences having a length of 64. In this case, the golay sequences may be represented as shown in Table 1 and Table 2 described above.

As another example, whether the received wake-up packet is the specific wake-up packet may be determined based on a value of a field included in a MAC frame of the received wake-up packet. For example, when the value of the field is 1111, the received wake-up packet may be determined as the specific wake-up packet indicating execution of the specific operation.

In another example, the MAC frame of the received wake-up packet may include a field and a subfield, and whether the received wake-up packet is the specific wake-up packet may be determined based on the field and the subfield included in the MAC frame of the received wake-up packet. The value of the field may indicate a service for the wake-up packet, and the value of the subfield may indicate a specific operation in the service. For example, when the value of the field is 1111 and the value of the subfield is 1111, the received wake-up packet may be determined as a time-critical message for the V2X, i.e., as a specific wake-up packet indicating execution of the specific operation.

In step S1520, when the received wake-up packet is the specific wake-up packet, the WUR terminal may perform the specific operation indicated by the specific wake-up packet. The specific operation may be an operation of displaying visual information and ringing a notification beep. The visual information may indicate a preset risk notification image or video. In addition, the specific operation may indicate a risk notification operation. The main radio module of the WUR terminal may display predetermined visual information and ring a notification beep.

Meanwhile, the method disclosed in FIG. 15 may be performed by a WUR terminal including a WUR module, a main radio module, and a processor (e.g., a central processing unit (CPU) or a modem, etc.). For example, step S1500 of FIG. 15 may be performed by the WUR module of the WUR terminal and steps S1510 and S1520 may be performed by the processor of the receiving terminal.

In this case, the processor of the WUR terminal may determine whether the received wake-up packet is a specific wake-up packet indicating execution of a specific operation. For example, whether the received wake-up packet is the specific wake-up packet may be determined based on a sequence combination applied to a subband included in a wake-up preamble field of the received wake-up packet. Here, the WUR terminal may further include a memory for storing information on a specific sequence combination indicating execution of the risk notification operation, and if the sequence combination applied to the subband of the received wake-up packet is the specific sequence combination, the received wake-up packet may be determined as the specific wake-up packet. When it is determined that the received wake-up packet is the specific wake-up packet, the processor of the WUR terminal may perform the risk notification operation indicated by the specific wake-up packet. Specifically, the processor may perform an operation of displaying predetermined visual information through a display unit of the WUR terminal and/or an operation of ringing a notification beep through a speaker of the WUR terminal. Further, when the received wake-up packet is not determined as the specific wake-up packet, that is, when the sequence combination applied to the subband of the received wake-up packet is not the specific sequence combination, the processor of the WUR terminal may wake up the main radio module, i.e., operate the main radio module in an activated state, and instruct an operation of receiving the wake-up packet. For example, the processor may instruct the main radio module to transmit a reassociation frame, and the main radio module may transmit the reassociation frame to a transmitting terminal.

As another example, whether the received wake-up packet is the specific wake-up packet may be determined based on a value of a field included in a MAC frame of the received wake-up packet. Here, the WUR terminal may further include a memory for storing information on a specific value indicating execution of the risk notification operation, and if a value of a field included in the MAC frame of the received wake-up packet is the same as the specific value, the received wake-up packet may be determined as the specific wake-up packet. Specifically, the specific value may be 1111, and information on the specific value may be stored in the memory. Next, when the value of the field included in the MAC frame of the received wake-up packet is 1111, the received wake-up packet may be determined as the specific wake-up packet indicating execution of the specific operation. When it is determined that the received wake-up packet is the specific wake-up packet, the processor of the WUR terminal may perform the risk notification operation indicated by the specific wake-up packet. Specifically, the processor may perform an operation of displaying predetermined visual information through a display unit of the WUR terminal and/or an operation of ringing a notification beep through a speaker of the WUR terminal. Further, when the received wake-up packet is not determined as the specific wake-up packet, that is, when the sequence combination applied to the subband of the received wake-up packet is not the specific sequence combination, the processor of the WUR terminal may wake up the main radio module, i.e., operate the main radio module in an activated state, and instruct an operation regarding reception of the wake-up packet. For example, the processor may instruct the main radio module to transmit a reassociation frame, and the main radio module may transmit the reassociation frame to a transmitting terminal.

According to the present disclosure described above, the wake-up packet indicating execution of a risk notification operation can be signaled adaptively according to a user's situation, so that the WUR terminal may efficiently save power and reduce a risk notification operation time.

In addition, according to the present disclosure, the wake-up packet indicating execution of the risk notification operation can be signaled to the WUR terminal in a situation requiring a response within a short time, and thus a time for performing the risk notification operation may be shortened.

The steps described above may be omitted or replaced by another step of performing a similar/same operation according to an embodiment.

In the above exemplary systems, although the methods have been described on the basis of the flowcharts using a series of the steps or blocks, the present disclosure is not limited to the sequence of the steps, and some of the steps may be performed at different sequences from the remaining steps or may be performed simultaneously with the remaining steps. Furthermore, those skilled in the art will understand that the steps shown in the flowcharts are not exclusive and may include other steps or one or more steps of the flowcharts may be deleted without affecting the scope of the present disclosure.

When the embodiments of the present disclosure are implemented in software, the above-described method may be implemented by modules (processes, functions, and so on) that perform the functions described above. Such modules may be stored in memory and executed by a processor. The memory may be internal or external to the processor, and the memory may be coupled to the processor using various well known means. The processor may comprise an application-specific integrated circuit (ASIC), other chipsets, a logic circuit and/or a data processing device. The memory may include a ROM (read-only memory), a RAM (random access memory), a flash memory, a memory card, a storage medium, and/or other storage device.

What is claimed is:

1. A method of receiving a packet in a wireless local area network (WLAN) system, the method comprising:
receiving, by a wake-up radio (WUR) terminal including a main radio module and a WUR module, a wake-up packet;
determining, by the WUR terminal, whether the received wake-up packet is a specific wake-up packet indicating execution of a risk notification operation; and
performing, by the WUR terminal, the risk notification operation indicated by the specific wake-up packet when the received wake-up packet is the specific wake-up packet.

2. The method of claim 1, wherein
the risk notification operation is an operation of displaying visual information and ringing a notification beep.

3. The method of claim 2, wherein
whether the received wake-up packet is the specific wake-up packet is determined based on a sequence combination applied to a subband included in a wake-up preamble of the received wake-up packet.

4. The method of claim 3, wherein
the sequence combination is a combination of golay sequences having a length of 64.

5. The method of claim 2, wherein
whether the received wake-up packet is the specific wake-up packet is determined based on a value of a field included in a medium access control (MAC) frame of the received wake-up packet.

6. A method of transmitting a packet in a WLAN system, the method comprising:
generating, by a transmitting terminal, a specific wake-up packet for a wake-up radio (WUR) terminal including a main radio module and a WUR module, the specific wake-up packet indicating execution of a risk notification operation of the WUR terminal; and
transmitting, by the transmitting terminal, the wake-up packet to the WUR terminal.

7. The method of claim 6, wherein
the risk notification operation is an operation of displaying visual information and ringing a notification beep.

8. The method of claim 7, wherein
a specific sequence combination is applied to a subband included in a wake-up preamble field in the specific wake-up packet, and the specific sequence combination is a sequence combination previously set to indicate execution of the risk notification operation.

9. The method of claim 7, wherein
the specific wake-up packet comprises a field having a specific value in a medium access control (MAC) frame, and the specific value is a value previously set to indicate execution of the risk notification operation.

10. A wake-up radio (WUR) terminal for receiving a packet in a WLAN system, the WUR terminal comprising:
a WUR module configured to receive a wake-up packet and to determine whether the received wake-up packet is a specific wake-up packet indicating execution of a risk notification operation; and
a main radio module configured to perform the risk notification operation indicated by the specific wake-up packet when the received wake-up packet is the specific wake-up packet.

11. The WUR terminal of claim 10, wherein
the risk notification operation is an operation of displaying visual information and ringing a notification beep.

12. The WUR terminal of claim 11, wherein
whether the received wake-up packet is the specific wake-up packet is determined based on a sequence combination applied to a subband included in a wake-up preamble of the received wake-up packet.

13. The WUR terminal of claim 12, wherein
the sequence combination is a combination of golay sequences having a length of 64.

14. The WUR terminal of claim 11, wherein
whether the received wake-up packet is the specific wake-up packet is determined based on a value of a field included in a medium access control (MAC) frame of the received wake-up packet.

15. A wake-up radio (WUR) terminal for receiving a packet in a WLAN system, the WUR terminal comprising:
a WUR module configured to receive a wake-up packet; and
a processor configured to determine whether the received wake-up packet is a specific wake-up packet indicating execution of a risk notification operation and to perform the risk notification operation indicated by the specific wake-up packet when the received wake-up packet is the specific wake-up packet.

16. The WUR terminal of claim 15, further comprising:
a memory configured to store information on a specific value indicating the execution of the risk notification operation,
wherein the received wake-up packet is determined as the specific wake-up packet when a value of a field included in a medium access control (MAC) frame of the received wake-up packet is the same as the specific value.
